(19) United States
(12) Patent Application Publication
(10) Pub. No.: US 2003/0105666 A1
(43) Pub. Date: Jun. 5, 2003

(54) Systems and methods for providing incentives to consumers to review distributed content

(76) Inventors: Howard Taub, San Jose, CA (US); Stephen T. Gase, Round Rock, TX (US); Ross R. Allen, Belmont, CA (US); Barclay J. Tullis, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/996,899

(22) Filed: Nov. 30, 2001

(51) Int. Cl. G06F 17/60

(52) U.S. Cl. 705/14

(57) ABSTRACT

Systems and methods are described for providing an incentive to potential consumers who receive e-mail advertisements or other content to render the advertisement on a display or a printer. An advertiser distributes a content packet to one or more consumers. The content packet includes a message and a value that the consumer will receive if the consumer renders the message. The content packet also includes a message identifier for tracking purposes and a bank account identifier that identifies an advertiser bank account. A pre-configured rules module on a consumer device determines if the message will be rendered according to the value assigned to the packet. If the message is rendered, the consumer notifies the advertiser bank that the message was rendered according to instructions contained in the packet, and the value is transferred from the advertiser bank to a consumer account. A sensor on a consumer printer is used to verify that the message was printed. The systems and methods may also be used to transfer valuable content by e-mail or printer mail in return for payment from a consumer's bank to a sender's bank.

### TECHNICAL FIELD

The systems and methods that are described herein relate generally to electronic content distribution systems. More particularly, the systems and methods described herein relate to distributing electronic content to consumers for display or printing and providing an incentive to the consumer to review the distributed content.

### BACKGROUND

In a free market economy, where consumer markets are driven by competition between providers of goods, a provider wishing to compete for consumer business must make potential customers aware of the advantages and benefits of the provider's product or service. Such a provider must rely on effective marketing campaigns to educate potential customers about the product.

Mass mailings are but one way that provider messages are distributed to potential consumers. Such mailings are commonly referred to as “junk mail.” Although much of unwanted junk mail is delivered to consumers daily, there is no doubt that the majority of consumers take an interest in at least a portion of the junk mail that is received. For instance, a person may casually discard all such mailings received except for pizza coupons from a particular pizza restaurant. However, the consumer must sort through several pieces of junk mail before obtaining the desired pizza coupon. In addition, the consumer must sort through junk mail to identify and retain regular mail, such as personal letters, bank statements, bills, etc.

Techniques are developing that allow a provider of goods or services to send information—or “content”—to potential consumers electronically. The content (assume an advertisement) is formulated on an advertiser, or provider, computing unit and is transmitted—most likely via e-mail or other electronic communication method—to a host of potential consumers. This serves the provider well, economically speaking. The provider no longer has to spend money on envelopes, paper, printing ink, postage, etc. Also, the provider no longer has a lag time of postal service delivery. Messages are delivered in an instant, rather than taking the typical one to three days to arrive in the regular mail.

Such techniques also provide an advantage over faxing services that provide advertisements or information—such as a newsletter—directly to a facsimile machine. Electronic delivery occurs at two to twenty times the speed of fax delivery. In addition, no long distance charges are incurred for sending information to consumers located some distance away from the provider.

But there is a concern for placing potentially burdensome amounts of new e-mail onto the Internet. Anti-spamming laws are already in force to prevent unwanted e-mail advertisements from being pushed onto consumers, but the laws hardly begin to prevent such spamming from occurring on a regular basis.

Given these considerations, the benefits of moving from conventional mass mailing techniques to e-mail based mass mailing techniques seem to weigh heavily in favor of the provider. The consumer realizes little, if any, benefit. In fact, consumers may actually begin to incur costs that they do not bear with conventional mass mailing techniques. Time, for one, is a resource that every consumer must expend to sift through potential mountains of new, and mostly unwanted, e-mail advertisements. If messages are sent to a fax or directly to a printer, the consumer is then burdened with the expense of the consumable resources used to print the messages, e.g., paper, toner, ink, etc.

If electronic delivery of printed content is to work successfully, these costs that are borne by the recipients of the content must be seriously addressed.

### SUMMARY

The systems and methods for providing incentives to consumers to review electronically distributed content that are described herein provide ways to compensate a consumer for taking the time and expending consumable resources for displaying and/or printing content distributed from a provider.

The described implementations contemplate systems and methods for distributing e-mail or printed mail (e-mail sent directly to a printer) so that a sender can offer an incentive to a consumer to review the material sent by the sender. The incentive compensates the consumer for the time and material expended in reviewing the sender's message. The consumer is not overly burdened, for the sender can bypass review of most or all of the messages sent.

In one implementation, an advertiser distributes a content packet to one or more consumers. The content packet includes a content message that may be a printable message or an audio/visual message that may be displayed and/or played on some type of electronic device.

The advertiser constructs the content packet on a computing device, such as an e-mail server. The content packet includes the content message and a rendering value that is offered to receiving consumers to render the message or a portion thereof. It is noted that the term “advertiser,” as used herein, can include distribution of news. In the case of advertiser-supported news or product announcements, the rendering value may be to cover or defray the cost to the receiving consumer of printing at least portions of the content.

In various implementations, one or more of the following may also take place:

(a) the advertiser may attach a bank account identifier to the content packet. The bank account identifier identifies a bank account owned by the advertiser from which money will be withdrawn;

(b) the advertiser may attach a message identifier to the content packet that helps track the messages and the payments offered with the messages;

(c) the advertiser may attach a second rendering value to the content packet. In this case, the first rendering value may represent an amount offered to the consumer for displaying the message, while the second rendering value represents an amount offered to the consumer for printing the message. Since printing a message requires the consumer to incur more costs, the second rendering value may be greater than the first rendering value. The first and second rendering values may be many-fold and correspond to various portions of the content.

(d) the advertiser may attach finishing, or rendering, instructions to the content packet. The instructions are requests and/or requirements for the consumer and the consumer's hardware. For example, the advertiser may require that a brochure sent to the consumer be printed in color and stapled.

In one implementation, the advertiser digitally signs the content packet using standard public key cryptography. The digital signature prevents the message from being modified and can be used to confirm the identity of the advertiser. Furthermore, the printer may add the equivalent of a watermark or other device for certifying the content of the printed material.

Once the content packet is constructed, the advertiser sends the content packet to one or more consumers via e-mail, Internet Printing, etc. Prior to the arrival of the content packet, the consumer has installed an e-mail application or an Internet-enabled printer. As part of the installation process, the consumer determined whether to receive message from unknown parties (junk mail advertisers) and under what conditions those messages should be viewed, played and/or printed. As part of the options available to the consumer, the consumer decided that a page of material was worth $0.10 of his time to read, and $0.25 of his time and resources to print and then read. The content packet may also contain choices and means for designating a form of payment desired, such as crediting the consumer's bank account or printing credit or redemption slips on the consumer's printer.

Upon receipt of the content packet by the consumer's e-mail application or printer, details of the printing/viewing reimbursement are extracted from the content packet and the e-mail application or printer that receives the content packet. The e-mail application or printer applies the rules previously configured by the consumer to the attributes of the incoming content packet. If the content packet does not satisfy the rules, the content packet is deleted.

If the content packet does satisfy the rules, then the e-mail application or printer sends a request to the bank account identified in the content packet. The request asks such questions as “Does the account exist?”, “Are there sufficient funds to cover the transaction?”, “Does the packet id make sense?” The bank sends a reply to the consumer that answers the particulars of the request.

Based on the consumer's rules, the advertiser's message is displayed, played or printed. The consumer then submits a certificate to the advertiser's bank that includes a consumer bank account identifier that identifies a bank account owned by the consumer in which the funds are to be transferred. Alternatively, the consumer may print a credit or redemption slip on the consumer's printer.

In one implementation, the consumer's hardware includes a sensor to verify that the message has been rendered. In this case, the certificate sent to the advertiser's bank includes a certification from this sensor that the message was indeed rendered by the consumer. If the sensor does not detect a successful rendering, another attempt is made to render the message. If unsuccessful after a pre-determined number of attempts, the process is aborted.

The advertiser's bank then transfers funds to the consumer's bank account. In one implementation, the advertiser's bank (or the consumer's bank) notifies the consumer when this transaction has been completed. If the consumer does not receive such a confirmation within a pre-specified time period, the a notification message is displayed to the consumer.

As an alternative to sending a request to the advertiser's bank, the consumer may send a similar request to the advertiser. The advertiser would then notify the advertiser's bank and request that a certain amount be transferred to the consumer's bank account. The advertiser's bank may then notify the advertiser of the successful completion of the transfer, and the advertiser may then notify the consumer of the same.

In another implementation, the process is used to allow a consumer to acquire valuable content (such as an industry newsletter or document) from a publisher and print it to the consumer's printer. After the printing has successfully completed, the consumer would request the consumer's bank to transfer funds to the publisher's account, and/or a credit or redemption slip may be printed or stored for later printing.

### BRIEF DESCRIPTION OF THE DRAWINGS

A more complete understanding of exemplary methods and arrangements of the invention may be had by reference to the following detailed description when taken in conjunction with the accompanying drawings wherein:

FIG. 1 is a block diagram of a system showing the interaction between an advertiser server and a consumer computer implementing the present invention(s).

FIG. 2 is a block diagram of a printer configured to implement the present invention(s).

FIG. 3 is a flow diagram depicting a method for distributing a content packet to one or more consumers and providing an incentive for the consumer(s) to render a message included in the content packet.

FIG. 4 is a flow diagram depicting a method for receiving and processing a content packet from an e-mail distributor in accordance with the present invention(s).

### DETAILED DESCRIPTION

The invention is illustrated in the drawings as being implemented in a suitable computing environment. Although not required, the invention will be described in the general context of computer-executable instructions, such as program modules, to be executed by a computing device, such as a personal computer, a hand-held computer or portable electronic device. Generally, program modules include routines, programs, objects, components, data structures, etc., that perform particular tasks or implement particular abstract data types. Moreover, those skilled in the art will appreciate that the invention may be practiced with other computer system configurations, including multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

General reference is made herein to one or more printing device. As used herein, “printing device” means any electronic device having data communications and data storage capabilities, and functions to render printed characters on a print medium. A printing device may be a printer, fax machine, copier, plotter, and the like. The term “printer” includes, but is not limited to, laser printers, ink jet printers, dot matrix printers, dry medium printers, copiers, facsimile machines and plotters. Although specific examples may refer to one or more of these printers, such examples are not meant to limit the scope of the claims or the description, but are meant to provide a specific understanding of the described implementations.

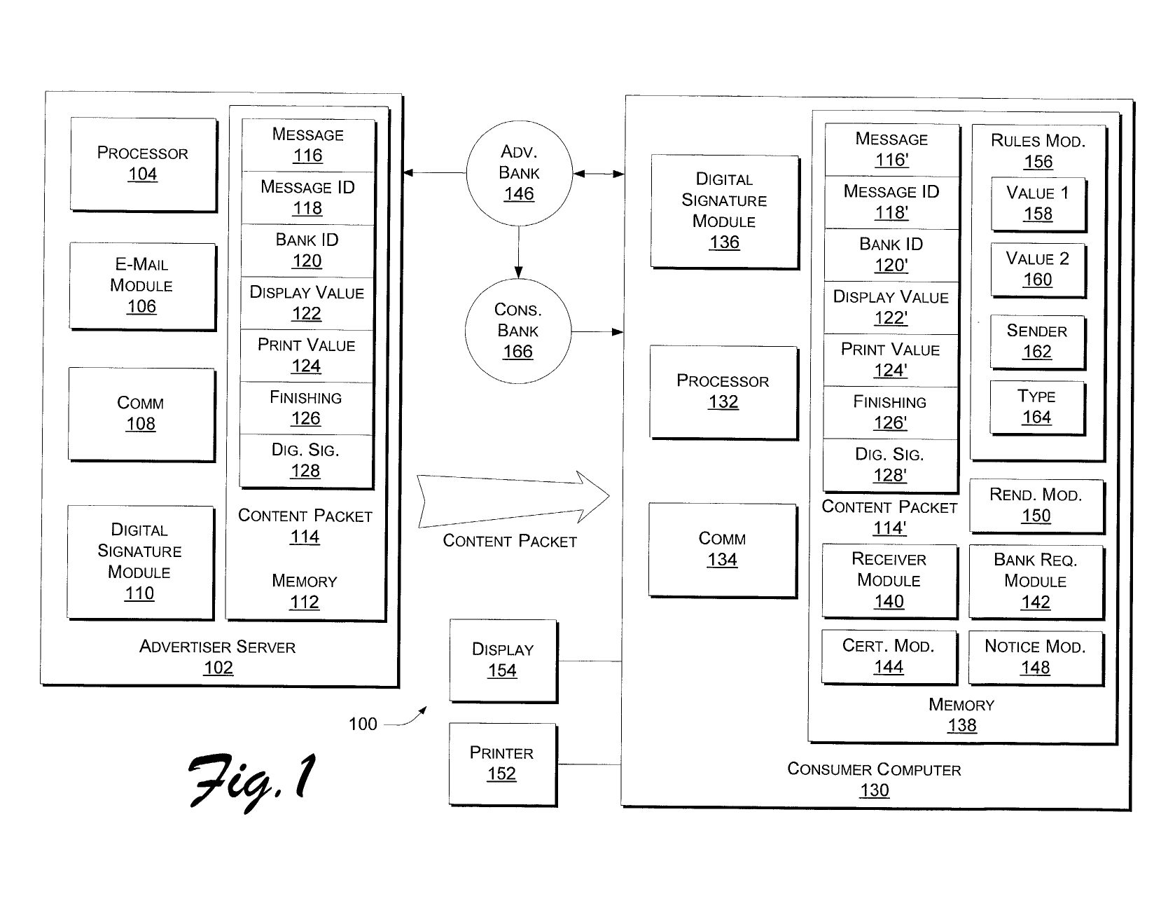

FIG. 1 is a block diagram of a system 100 constructed in accordance with the invention(s) described herein. An advertiser server 102 operated by an advertiser includes a processor 104, an e-mail module 106, a communications unit 108 and a digital signature module 110. The advertiser server 102 also includes memory 112.

A content packet 114 is stored in the memory 112 and includes a content message 116. The content message is a printable message, such as an advertisement, or audio/visual content suitable for playing/displaying on an electronic device. The content packet 114 also includes a message identifier 118 that corresponds to the particular content message 116 and facilitates transactions involving the content packet 114. A bank account identifier 120 included in the content packet 114 identifies an advertiser bank and bank account that is used to compensate a consumer that renders the content message 116.

The content packet 114 also includes a display value 122 and a print value 124. The display value 122 is an amount, in monetary units or credits, that the advertiser is willing to pay a consumer for playing or displaying the content message 116. The print value 124 is an amount, in monetary units or credits, that the advertiser is willing to pay a consumer for printing the content message 116. Finishing instructions 126 are included in the content packet and are rules set for the by the advertiser. A consumer must satisfy these rules before the consumer is entitled to receive the value identified in the content packet 114. For instance, the advertiser may require that the content message 116 be printed in color before the print value 124 is transferred to the consumer. Any finishing details required by the advertiser may be included in the finishing instructions 126.

The content packet 114 is digitally signed with a digital signature 128 that uniquely identifies the advertiser. A consumer may use the digital signature to verify the source of the content packet 114 and to insure that the content packet 114 has not been modified since it was digitally signed at the advertiser server 102.

The system 100 also includes a consumer computer 130. The consumer computer 130 includes a processor 132, a communications unit 134 and a digital signature module 136. Memory 138 in the consumer computer 130 stores a copy of the content packet 114′ that is received from the advertiser server 102. The content packet 114′ includes the same information as content packet 114, namely, a content message 116′, a message identifier 118′, a bank account identifier 120′, a display value 122′, a print value 124′, finishing instructions 126′ and a digital signature 128′. The memory 138 also stores a receiver module 140 that is configured to receive the content packet 114 from the advertising server 102. A bank request module 142 stored in the memory 138 is configured to verify that the bank account identified by the bank account identifier 120′ exists and that sufficient funds are in the account to satisfy the terms set forth in the content packet 114′. The memory 138 further includes a certification module 144 configured to confirm that the content message 116′ has been rendered and to send a certification to the advertiser server 102 or to an advertiser bank 146 that the content message 116′ has been rendered.

A notice module 148 is stored in the memory 138 and is configured to receive notice from the advertiser bank 146 that funds have been transferred. The notice module 148 is also configured to provide notice to the consumer if such notice has not been received from the advertiser bank 146 within a specified period of time since the content message 116′ was rendered. The memory 138 also stores a rendering module 150 that initiates rendering of the content message 116′, i.e., sending the content message 116′ to a printer 152 to be printed or to a display 154 to be displayed.

A rules module 156 is also stored in the memory 138. The rules module 156 contains a first value 158 (“Value 1”) that identifies an amount required of a sender to render the content message 116′ in a first way, such as displaying the content message 116′. The rules module 156 also contains a second value 160 (“Value 2”) that identifies an amount required of a sender to render the content message 116′ in a second way, such as printing the content message 116′. The rules module 156 also includes a sender field 162 and a type field 164. The sender field 162 identifies only those senders from which the consumer computer 130 will accept unsolicited content packets 114′. The sender field 162 may be set to include all content packets 114′ delivered to the consumer computer 130. The type field 164 identifies specific types of content packets 114′ that will be accepted by the consumer computer 130. For example, the type field 164 may indicate that only content packets 114′ that include a valuable coupon as the content message 116′.

A consumer bank 166 is also shown in FIG. 1. The consumer bank 166 is a bank in which a consumer owns a bank account. The bank account in the consumer bank 166 is the account where funds will be transferred from the advertiser bank 146.

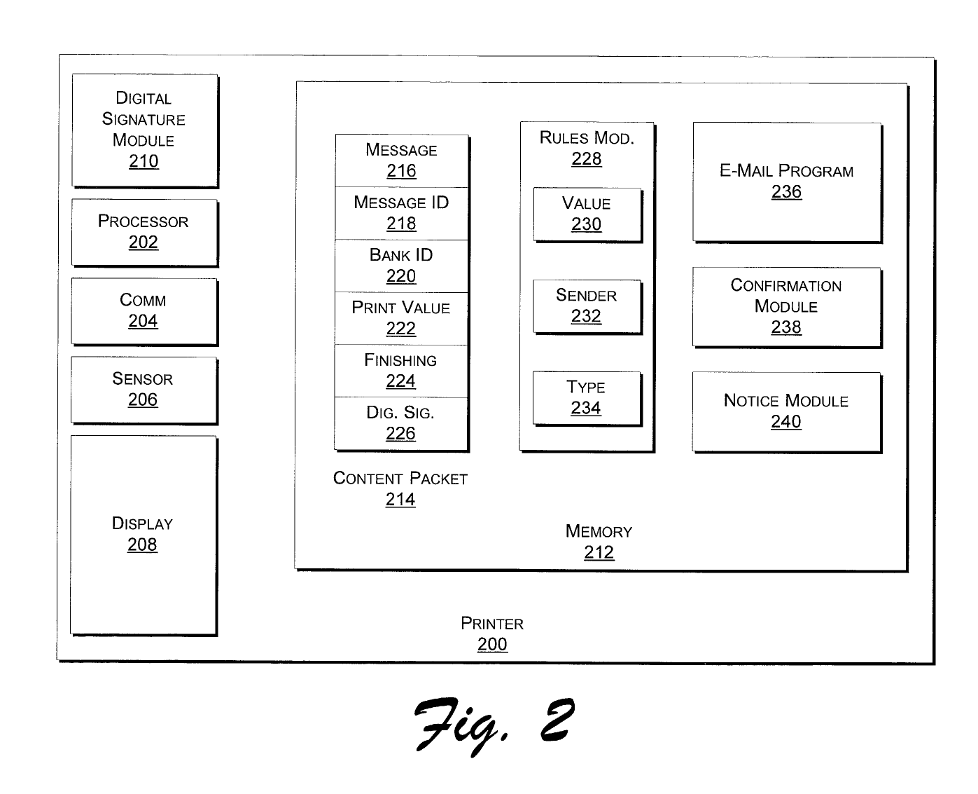

It is noted that the present invention may be implemented in a properly configured printer. In that case, e-mail messages are sent directly to the printer for printing instead of being sent to a computer for display or printing. FIG. 2 is a block diagram of a printer 200 in which the present inventions may be implemented. The printer 200 includes a processor 202, a communications unit 204, a sensor 206 a display 208 and a digital signature module 210.

The printer 200 also includes memory 212 that stores a content packet 214 as previously described. The content packet 214 includes a content message 218, a message identifier 220, a bank account identifier 222, a print value 224, finishing instructions 226 and a digital signature 228. It is noted that the content packet 214 in this instance only includes one value, the print value 224. This is because the printer 200 only has one way of rendering the content message 218. It is also noted that the content packet 214 may include more than one value, similar to the content packets 116, 116′ shown in FIG. 1. This is because a sender may not distinguish between a consumer that receives content packets on a computer and a consumer that receives content packets on a printer. In such a case, the printer 200 only utilizes the printer value 224 contained in the content packet 214.

The memory 212 also includes a rules module 228 that contains the requirements set forth by an owner of the printer 200 for receiving content packets 214 from advertisers or other senders. The rules module 228 functions similarly to the rules module 156 of the consumer computer 130 shown in FIG. 1. The rules module 228 includes a value 230 that indicates an amount required to print the content message 218, a sender field 232 that indicates the parties from whom content packets 214 will be accepted by the printer 200, and a type field 234 that indicates the types of content messages 216 that will be accepted for printing by the printer 200.

The memory 212 also stored an e-mail program 236 that controls the receipt and transmission of e-mail messages, including those that include content packets 214. A confirmation module 238 module stored in the memory 212 is configured to verify that a content message 216 was printed from the printer 200. The memory also includes a notice module 240 configured to send a notification to the advertiser (or other sender) or to the bank account of the advertiser (or other sender) that the content message 216 has successfully printed from the printer 200.

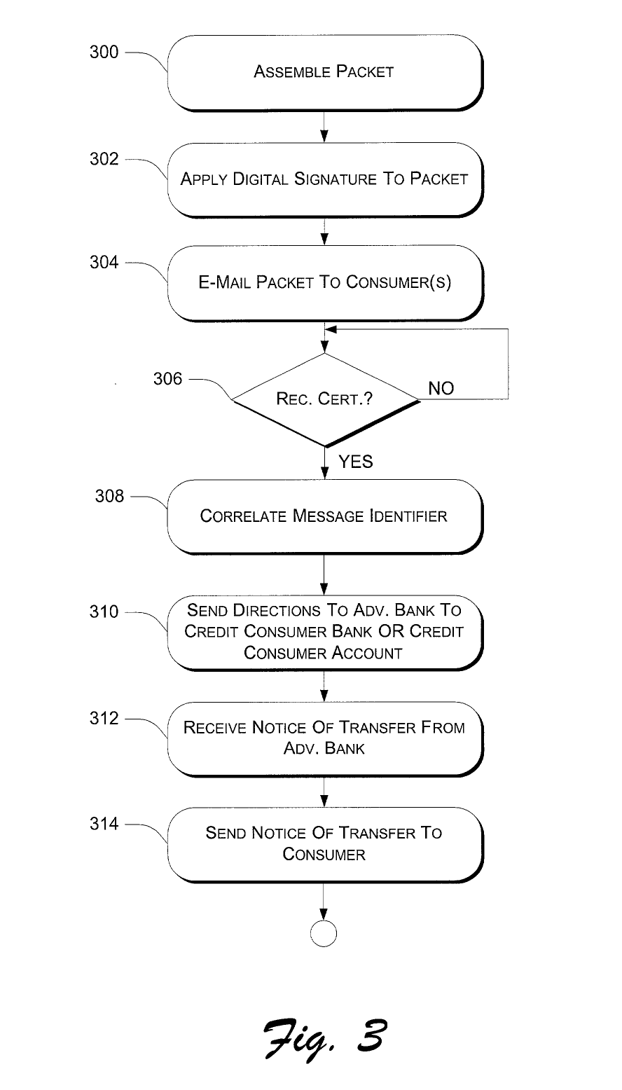

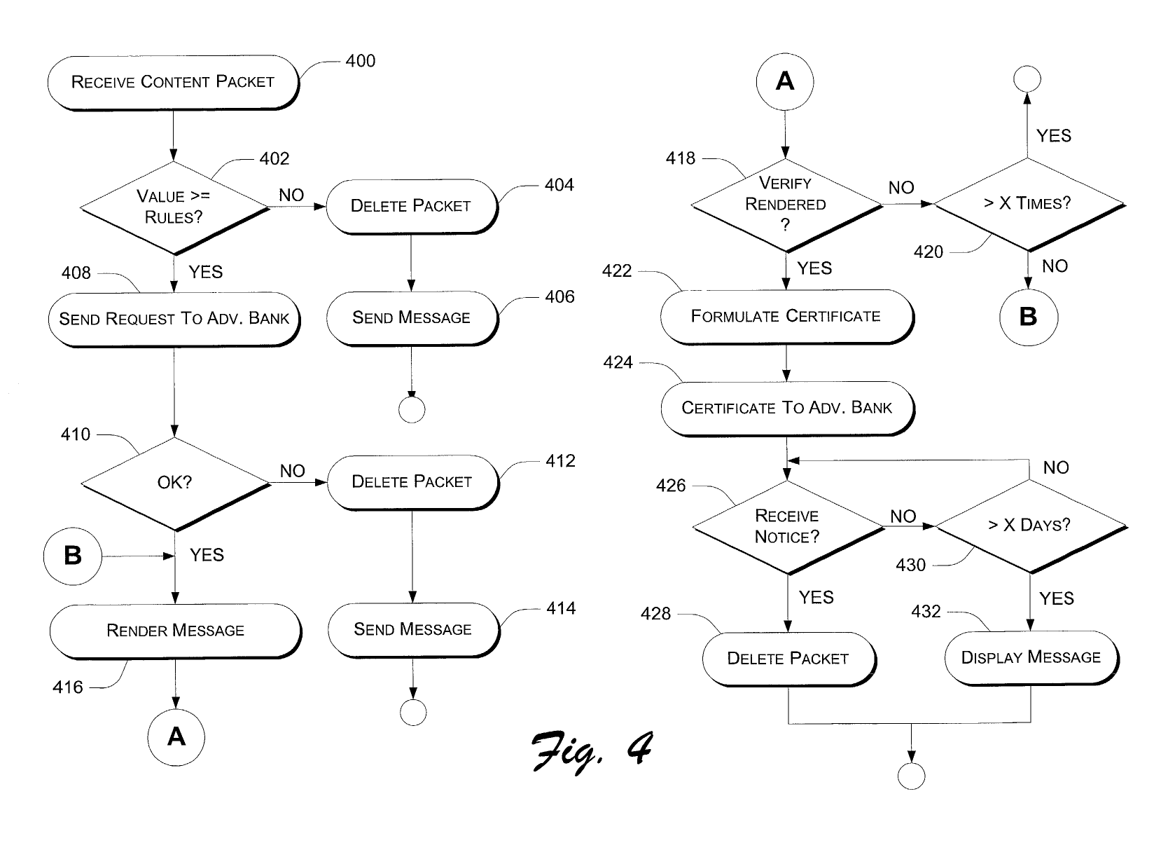

The functions of the features shown in FIG. 1 and FIG. 2 will be described in greater detail in the discussion of FIG. 3 and FIG. 4, below.

FIG. 3 is a flow diagram depicting a method for constructing and distributing content packets in accordance with the present invention. Continuing reference will be made to the elements and reference numerals of FIG. 1 in the following discussion. It is noted that although the following discussion refers to transactions between an advertiser server and a consumer computer as shown in FIG. 1, the methods described may also be implemented with an e-mail enabled printer as shown in FIG. 2. However, a separate discussion will not be had with specific reference to FIG. 2. It will be apparent to those skilled in the art from the discussion with reference to FIG. 1 how the methods may be utilized with a printer. Any instances wherein there is a significant difference between the methods utilized in a computer and the methods utilized in a printer will be pointed out.

At step 300, the e-mail module 106 of the advertiser server 102 assembles the content packet 114. A content message 116 that contains an advertisement message or some other content to be distributed in included in the content packet. The content message 116 may be previously stored in the memory 112 or it may be retrieved from another source. A message identifier 118 that uniquely corresponds with the content message 116 is stored in the content packet 114. The message identifier 118 is used in communications with consumers and banks to identify the content message 116 that is to be or has been rendered.

The e-mail module 106 attaches a bank account identifier 120 to the content packet 114. The bank account identifier 120 uniquely identifies an advertiser bank 146 and an account in the bank 146 that will be used to fund transfers for rendering the content message 116.

Two values are attached to the content packet 114: a display value 122 that indicates an amount that will be paid to a consumer in return for the consumer displaying the content message 116; and a print value 124 that indicates an amount that will be paid to a consumer in return for the consumer printing the content message 116. One or more other values (not shown) may be included in the content packet 114. The other values indicate a value that will be paid to a consumer in return for the consumer rendering the content message 116 in another way, for example, by playing audio content on a playback device.

The e-mail module 106 also attaches finishing instructions 126 to the content packet 114. The finishing instructions 126 are rendering instructions that the advertiser requires be implemented before payment is made for the rendering. For example, the advertiser may require a message to be printed in color before the advertiser is willing to pay for the rendering.

The digital signature module 110 then attaches a digital signature 128 to the content packet 114 at step 302. The digital signature 128 is used by a consumer that receives the content packet 114 to verify that the contents of the content packet 114 have not changed since the digital signature 128 was applied. Also, the digital signature 128 can be used to verify the source of the content packet 114.

At step 404, the content packet 114 is e-mailed to one or more consumers or potential customers. Any method known in the art for transmitting the content packet 114 to consumers may be utilized. For example, an Internet printing method may be used wherein the content packet 114 is sent via the Internet directly to a printer (FIG. 2, 200) that is capable of communicating directly with the Internet and printing content messages received in that manner.

After the content packet 114 is sent to consumers, the advertiser server 102 waits to receive a certificate from a consumer verifying that the content message 116 was rendered (step 406). No action is taken as long as no such certificate is received (“No” branch, step 406). When a certificate is received that verifies that a content message 116 has been rendered (“Yes” branch, step 406), the e-mail module 106 correlates the message identifier 118 identified in the return certificate with the content packet 114 with which it was sent (step 408).

When the content packet 114 is identified, the e-mail program can identify the amount due to be transferred to the consumer who sent the certificate. Included in the certificate is bank account information for a consumer account. At step 410, the e-mail module 106 transmits directions to the advertiser bank 146 to transfer the appropriate funds to the consumer's account at the consumer bank 166. When the transfer is effectuated, the advertiser bank 146 sends notice to the advertiser server 102 that the transfer has been completed at step 412. At step 414, the e-mail module 106 sends notice to the consumer that the transfer has been completed.

It is noted that steps 410 through 414 may be omitted if the consumer communicates directly with the advertiser bank 146. In such a case, the consumer sends the certificate directly to the advertiser bank 146. When the transfer is accomplished, the advertiser bank 146 sends a notice to the consumer. The advertiser may also receive notice of the conclusion of the transfer.

FIG. 4 is a flow diagram that depicts a method performed by a consumer computer or e-mail ready printer to accomplish the objectives stated herein. At step 400, the receiver module 140 of the consumer computer 130 receives the content packet 114 from the advertiser server 102. At step 402, the rules module 156 compares the display value 122′ and the print value 124′ to the first value 158 (“Value 1”) and the second value 160 (“Value 2”) stored in the rules module 156. The type of content message 116′ and the sender 102 are also checked against the values contained in the type field 164 and the sender field 162, respectively.

If either of the values are not satisfied or the type of content message 116′ or sender are not approved according to the preset rules (“No” branch, step 402), the content packet 114′ is deleted at step 404. A message is sent at step 406 to the sender that the content packet 114 was unacceptable.

If either of the values are satisfied and the sender and type of message are acceptable under the rules (“Yes” branch, step 402), then the bank request module 142 sends a request to the advertiser bank 146, requesting information to verify the existence of the identified account and whether there are funds in the account to satisfy the values identified in the content packet 114′. If the account or funds are invalid (“No” branch, step 410), then the content packet 114′ is deleted at step 412 and a message notifying the advertiser of the deletion is transmitted at step 414.

If, however, the accounts and funds are valid (“Yes” branch, step 410), then the rendering module 150 initiates rendering of the content message 116′ at step 416. How the content message 116′ is rendered depends upon the results from the rules module 156. If the value offered for displaying the content message 116′ is acceptable and the value offered for printing the content message 116′ is acceptable, then a pre-determined rule will apply to determine if the content message 116′ is displayed or printed. If only one of the values is acceptable, then the appropriate rendering corresponding to that value will occur.

The rendering module 150 initiates a print job by sending the content message 116′ to the printer 152. A display is initiated by sending the content message 116′ to a display device 154. The certification module 144 verifies that the rendering has occurred when the rendering module 150 initiates a rendering. In a preferable implementation, a printer (FIG. 2, 200) includes a sensor 208 that measures the mechanical performance of the printer 200 after a print job has been initiated. Only upon a successful signal from the sensor 208 will the certification module 144 verify that the content message 116′ has been printed.

At step 418, the certification module 144 is polled to determine if the content message 116′ has been rendered. If not (“No” branch, step 418), it is determined how many times a rendering has been attempted and this value is compared to a preset limit at step 420. If the limit has not been reached (“No” branch, step 420), then the rendering is attempted again (step 416). If the limit has been reached (“Yes” branch, step 420), then the process is aborted. A termination message may be displayed on the display 154 of the printer 152, 200 at this time.

If the rendering was successful (“Yes” branch, step 418), then the certification module 144 formulates a certificate at step 422. The certificate reflects that the content message 116′ corresponding to the message id 118′ has been successfully rendered and that a certain rendering amount is owed to the consumer. The certificate also contains bank account information for a consumer bank account. The certificate is sent to the advertiser bank 146 at step 426. The advertiser bank then transfers the appropriate funds from the advertiser's account to the consumer's account.

When the transfer has been completed, the notice module 148 receives notice from the advertiser bank 146 at step 426. The notice module 148 continues to wait for this notice as long as the notice has not been received (“No” branch, step 426) and a pre-determined time period (e.g., number of days) has not elapsed (“No” branch, step 430). If the time period expires without receiving the notice of transfer (“Yes” branch, step 430), then the notification module 148 displays a message to the consumer. When the notice is received (“Yes” branch, step 426), then the content packet 114′ is deleted from the memory 138.

Conclusion

The systems and methods described herein provide a way for an advertiser or other sender to reduce the costs of mass marketing efforts, while providing payment to compensate a consumer for the time and resources spent in receiving and reviewing the e-mail. The consumer is thus provided an incentive to render and review the advertiser's message.

1. A server from which a sender distributes content messages to one or more receivers, comprising:
a processor;
memory;
a content packet stored in the memory, the content packet including:
message content;
a sender bank identifier; and
a value that indicates an amount that the sender offers to credit a receiver for rendering at least a portion of the message content.

2. The server as recited in claim 1, wherein the content packet further comprises a message identifier that uniquely identifies the message content.

3. The server as recited in claim 1, wherein:
the value is a first value that indicates an amount that the sender offers to credit a receiver for rendering the message content on a display; and
the content packet further comprises a second value that indicates an amount that the sender offers to credit a receiver for printing the message content.

4. The server as recited in claim 1, wherein:
the value is a first value that indicates an amount that the sender offers to credit a receiver for rendering the message content on a display; and
the content packet further comprises a second value that indicates an amount that the sender offers to credit a receiver for playing audio/visual message content.

5. The server as recited in claim 1, further comprising a digital signature module configured to digitally sign the content packet.

6. The server as recited in claim 1, wherein the content packet further comprises finishing instructions that a receiver must fulfill before the value is credited to the receiver.

7. The server as recited in claim 1, wherein the value is a monetary value that is credited to a receiver bank account from a bank account identified by the sender bank identifier.

8. The server as recited in claim 1, wherein the value is a credit value that may be credited toward a product or service purchase.

9. The server as recited in claim 1, wherein the value is a credit/redemption slip.

10. The server as recited in claim 1, further comprising a program configured to construct the content packet and distribute the content packet to the one or more receivers.

11. The server as recited in claim 10, wherein the program is further configured to receive notice that the message content has been rendered and to recall a sent content packet if a notice of receipt is not received within a certain time period.

12. The server as recited in claim 1, further comprising a confirmation module configured to receive confirmation from the one or more receivers that the message content has been rendered.

13. An e-mail program stored on one or more computer readable media, comprising:
a receiver module configured to receive a content packet from one or more senders, the content packet including a content message, an advertiser bank account identifier, a value that the sender is willing to pay to render the content message, and finishing instructions detailing how the content message is to be rendered;
a bank request module configured to verify that an advertiser bank account identified by the advertiser bank account identifier in the content packet can satisfy the value identified in the content packet;
a rules module containing payments required to render the content message;
a rendering module configured to render the content message if the value meets or exceeds a value established in the rules module and if the bank request module verifies sufficient funds in the advertiser bank account to pay the value included in the content packet; and
a certification module configured to confirm that the content message has been rendered and to send a certification to the advertiser bank that the content message has been rendered.

14. The e-mail program as recited in claim 13, wherein the rules module is further configured to identify a first amount required for playing/displaying and audio/visual content message and a second amount required for printing a printable content message.

15. The e-mail program as recited in claim 13, further comprising a notice module configured to receive notice from the advertiser bank that funds have been transferred and to provide notification if such notice has not been received within a specified period of time since the content message was rendered.

16. The e-mail program as recited in claim 13, wherein the rendering module is further configured to initiate a print job to print the content message.

17. The e-mail program as recited in claim 13, wherein the rendering module is further configured to direct the content message to an audio/visual device for playback or display.

18. The e-mail program as recited in claim 13, wherein:
the value in the content packet is a first value that indicates an amount the sender is willing to pay to display the content message; and
the content packet further comprises a second value that indicates an amount the sender is willing to pay to print the content message.

19. The e-mail program as recited in claim 13, wherein the certification module is further configured to provide a customer bank account identifier that identifies a bank account to which funds are to be transferred from the advertiser bank.

20. A printer that embodies the e-mail program recited in claim 13.

21. A computer that embodies the e-mail program recited in claim 13.

22. A printer, comprising:
an e-mail module configured to receive an e-mail message from one or more senders, said e-mail message containing a content packet that includes a content message that is printable on the printer and a print value that identifies a value the sender is willing to pay to print the content message;
a rules module that contains a value required to print the content message and that is configured to print the content message if the print value is greater than or equal to the value in the rules module;
a print confirmation module configured to verify that the content message was printed; and
a notice module configured to notify the sender that the content message was printed on the printer.

23. The printer as recited in claim 22, wherein the controller is further configured to delete the content packet if the print value is less than the value contained in the rules module.

24. The printer as recited in claim 22, wherein the content packet further comprises a sender bank account identifier, the printer further comprising a funds verifier configured to verify that sufficient funds are in the sender bank account to pay the print value.

25. The printer as recited in claim 22, wherein the notice module is further configured to receive notice that funds have been transferred from the sender.

26. The printer as recited in claim 25, wherein the notice module is further configured to provide a notification that a funds transfer has not occurred if the notice that funds have been transferred from the sender is not received within a specified time period.

27. The printer as recited in claim 22, wherein the value is a monetary value.

28. The printer as recited in claim 22, wherein the value is a credit that may be redeemed with the sender.

29. The printer as recited in claim 22, wherein the value is a slip that can be used for a credit or for redemption.

30. A method, comprising:
assembling a content packet, the content packet including a content message and a rendering value;
sending the content packet to one or more receivers;
receiving notice that a receiver has rendered a content message from the content packet;
crediting the receiver that rendered the content message with an amount equal to the rendering value.

31. The method as recited in claim 30, wherein:
the content packet further comprises a content message identifier that corresponds to the content message in the content packet; and
the receiving notice further comprises receiving notice that a receiver has rendered a content message having a specific content message identifier.

32. The method as recited in claim 30, wherein:
the receiving notice further comprises receiving information identifying a bank account held by the receiver; and
the crediting the receiver further comprises crediting the receiver's bank account with a monetary value identified by the rendering value.

33. The method as recited in claim 30, wherein:
the receiving notice further comprises receiving information identifying a credit account held by the receiver; and
the crediting the receiver further comprises crediting the receiver's credit account with a number of credits identified by the rendering value.

34. The method as recited in claim 30, wherein the content message is printable.

35. The method as recited in claim 30, wherein the content message is an advertisement.

36. The method as recited in claim 30, wherein the content packet further includes a sender bank account identifier that may be used by a receiver to access a corresponding sender bank account to verify that the account exists and that there are sufficient funds in the account to cover the rendering value.

37. The method as recited in claim 30, wherein the content packet further includes finishing instructions that identify certain rendering requirements that must be met before the rendering value is applied to the receiver.

38. The method as recited in claim 30, wherein the rendering value is a first rendering value that indicates an amount credited for displaying the content message, and the content packet further includes a second rendering value that indicates an amount credited for printing the content message.

39. The method as recited in claim 30, further comprising digitally signing the content packet with a unique digital signature.

40. A method, comprising:
receiving a content packet from a sender, the content packet containing a content message and a rendering value, the rendering value indicating an amount the sender offers to credit for rendering the content message;
initiating rendering of the content message if the rendering value is greater than or equal to a pre-determined rendering limit;
notifying the sender that the content message has been rendered; and
sending credit instructions to the sender to receive credit for the rendering value.

41. The method as recited in claim 40, wherein the content message is an advertisement.

42. The method as recited in claim 40, wherein:
the rendering value is a first rendering value that indicates an amount the sender offers to credit for displaying the content message; and
the content packet further includes a second rendering value that indicates an amount the sender offers to credit for printing the content message.

43. The method as recited in claim 40, further comprising verifying that the sender has a bank account that contains sufficient funds to satisfy the rendering value, and wherein the content packet further includes a sender bank account identifier.

44. The method as recited in claim 40, further comprising verifying a digital signature that is included in the content packet.

45. The method as recited in claim 40, further comprising verifying that the content message has been rendered before notifying the sender that the content message has been rendered.

46. The method as recited in claim 40, wherein initiating rendering of the content message further comprises initiating a print job to print the content message.

47. The method as recited in claim 40, further comprising receiving notice that an amount indicated by the rendering value has been credited.

48. The method as recited in claim 47, further comprising issuing a notification that a notice of credit has not been received within a specified period of time since the content message was rendered.
